(19) United States
(12) Patent Application Publication
(10) Pub. No.: US 2006/0090707 A1
(43) Pub. Date: May 4, 2006

(54) Nectar feeding system

(76) Inventor: Robert W. Donegan, Highlands Ranch, CO (US)

Correspondence Address: MARTIN & HENSON, P.C., 9250 W 5TH AVENUE, SUITE 200, LAKEWOOD, CO, 80226, US

(21) Appl. No.: 10/980,619

(22) Filed: Nov. 2, 2004

(51) Int. Cl. A01K 39/00

(52) U.S. Cl. 119/72

(57) ABSTRACT

The present invention provides a feeding system for dispensing liquid food to a bird. The system includes a container of concentrated sugar solution that is dilutable with water at a selected dilution ratio of concentrate to water and a feeder to be supported by a support structure. The feeder includes a reservoir having a selected volume and an index marking correlating to a selected partial volume whereby the ratio of the partial volume to the difference between the selected volume and the partial volume is equal to the dilution ratio for the concentrate. The base of the feeder mounts to the reservoir and has at least one feed outlet to make the liquid in the reservoir available to the bird. The present invention is also directed to a method of providing nectar solution to hummingbirds.

### FIELD OF THE INVENTION

The present invention generally relates to feeders for dispensing foodstuff for birds and methods for feeding the same. More particularly, the present invention is directed to birdfeeders that dispense nectar solutions for consumption by hummingbirds. Specifically, the present invention is directed to hummingbird feeders and nectar solutions that, together, formulate an appropriately concentrated nectar solution for attracting and nourishing hummingbirds.

### BACKGROUND OF THE INVENTION

Bird-watching is a highly prevalent past-time in both urban and rural areas. The world is full of birds of numerous varieties in an astounding array of colors and designs. Many people enjoy viewing birds of various types, and an industry has grown up around products directed to improving the ability of persons to get close to birds. On one hand, many people venture into the outdoors, where binoculars and spotting scopes may be utilized to better view various birds in their natural habitats. Such an approach requires a certain degree of skill, however, in finding and spotting various species of birds. Another approach utilizes various means of attracting birds to one's residence or a desired viewing location, such as adjacent a home porch or window, where birds may be viewed at one's leisure.

In particular, the art of using bird feeders, bird baths, and the like has arisen to attract birds of various types to one's home. Different types of feeders have been developed, which each dispense foodstuffs that are preferred by a selected variety of bird which a person might desire to view. For example, seeds, grains, suets, and nectars are common foodstuffs that can be dispensed by a selected type of feeder.

Hummingbirds are one particularly interesting type of bird that persons commonly desire to view. The hummingbird family is found only in the Americas, and includes more than 300 species of birds. Hummingbirds are known for their rapid flight and their ability to hover in the air, such as at a food source, and fly backwards (the only birds capable of doing so). In particular, they feed on nectar and tiny insects found within flowers, generally hovering in front of a flower as they reach for food with long, extensible tongues. Their rapid wing beat produces a hum, and they are generally brightly colored and iridescent, thus particularly enjoyable to view. Many male hummingbirds have metallic green coloring with brightly colored throats, which are often a glittering red, blue, or emerald. They are often seen hovering or darting, and have been known to reach speeds up to 60 miles per hour in the air, beating their wings at 50 to 75 beats per second.

Various types of feeders have been developed to attract hummingbirds to a particular location for viewing. Many people hang such feeders from porches or backyard trees, so as to be able to watch various brightly colored birds arrive and depart, hovering or sometimes perching at the feeder in the interim to feed. Due to the enormous energy requirements of their particular flight patterns, hummingbirds require virtually constant feeding of high-sugar content foodstuffs. Accordingly, it is generally common to provide a nectar-like solution for hummingbirds from a brightly colored feeder designed to simulate the colors of flowers to which hummingbirds are generally attracted, such as red in particular.

The nectar solution typically needs to be replenished frequently due in part by the number of hummingbirds visiting the feeder, but also due to loss of the solution through evaporation or spillage. Nectar solution can be made by dissolving sugar in boiling or hot water in a certain ratio that provides a suitable concentration of sugar that is appealing to hummingbirds. Alternatively, there are readily available commercial nectar mixes and syrups that may be diluted in boiling or hot water, and are further provided with other vitamins to nourish the hummingbirds.

The preparation of nectar solutions is somewhat time consuming due to the need of having to first boil water in order to prepare the solution. As such, hummingbird feeders are often neglected in that the nectar solution is not changed as frequently as needed and sometimes are left empty until more solution is prepared. In many instances, the hassle of preparing nectar solution with boiled water serves as a deterrent to having hummingbird feeders to attract these wondrous creatures.

Accordingly, it can be seen that there remains a need to provide a new and improved nectar solution suitable for hummingbirds that eliminates the hassle of boiling water to provide an appropriate nectar solution. There is also a need to provide an aesthetically pleasing nectar feeder that is able to dispense the nectar solution to the feeding birds. There is also a need for a new and improved method of feeding hummingbirds.

### SUMMARY OF THE INVENTION

An object of the present invention to provide a new and useful nectar solution for hummingbirds that does not require boiling water to prepare.

Another object of the present invention is to provide a feeding system that incorporates a new and useful nectar solution and a new and useful hummingbird feeder, that cooperate with one another to provide a nectar solution to be dispended to hummingbirds.

Yet another object of the present invention is to provide a new method for feeding hummingbirds.

According to the present invention, then, a feeding system for dispensing liquid food to a bird is provided. The feeding system generally includes a container of concentrated sugar solution that is dilutable with water at a selected dilution ratio of concentrate to water as well as a hummingbird feeder adapted to be supported by a support structure. The hummingbird feeder includes both a reservoir with a reservoir outlet and a base adapted to mount to the reservoir.

The reservoir has a selected volume and an index marking thereon. The index marking correlates to a selected partial volume whereby the ratio of the partial volume to the difference between the selected volume and the partial volume is equal to the dilution ratio for the concentrate. The base of the feeder is adapted to mount to the reservoir and has at least on feed outlet in fluid communication with the reservoir outlet when in a mounted state whereby liquid in the reservoir is available to a bird at the feed outlet.

The present invention also provides a method of providing a nectar solution to hummingbirds. The method includes providing a concentrate that is dilutable with water at a selected dilution ratio of concentrate to water thereby to produce the nectar solution and the step of inverting a reservoir having a selected volume and an index marking thereon that is correlated to a selected partial volume whereby the ratio of the partial volume to the difference between the selected volume and the partial volume is equal to the dilution ratio for the concentrate. A partial volume of the concentrate and a sufficient volume of water adequate to dilute the concentrate are added to the reservoir. Thereafter, the reservoir is secured to a feeder base that is provided with at least one feed outlet such that the reservoir and the feed outlet are in fluid communication.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of the feeding system according to the exemplary embodiment of the present invention including a container of concentrated sugar solution and a solution feeder;

FIG. 2 is a front view in elevation of the container of the concentrated sugar solution, which is a component of the feeding system shown in FIG. 1;

FIG. 3 is a perspective view of the container of FIG. 2;

FIG. 4 is a top plan view of the container, showing the top wall and opening through which the concentrated sugar solution is poured;

FIG. 5 is a cross sectional view taken about lines 5-5 in FIG. 4;

FIG. 6 is an exploded perspective view of the humming bird feeder, which forms a component of the feeding system shown in FIG. 1;

FIG. 7(a) is a front view in elevation of the feeder reservoir shown inverted with a collected volume of nectar concentrate;

FIG. 7(b) is a front view in elevation of the feeder reservoir shown inverted with a selected volume of nectar concentrate and a selected volume of water; and

FIG. 7(c) is a front view in elevation of the humming bird feeder wherein the feeder reservoir now contains a mixture of the nectar concentrate and water.

### DETAILED DESCRIPTION OF THE EXEMPLARY EMBODIMENTS

The present invention relates to feeders that are adapted to dispense a foodstuff, such as a nectar solution, to various types of creatures, such as hummingbirds, orioles, and butterflies. In particular, the present invention relates to a hummingbird feeder that dispenses a nectar solution for consumption by hummingbirds. Specifically, the present invention is directed to a concentrated liquid nectar solution that, together with the hummingbird feeder of the present invention, provides an appropriately diluted nectar solution for attracting hummingbirds.

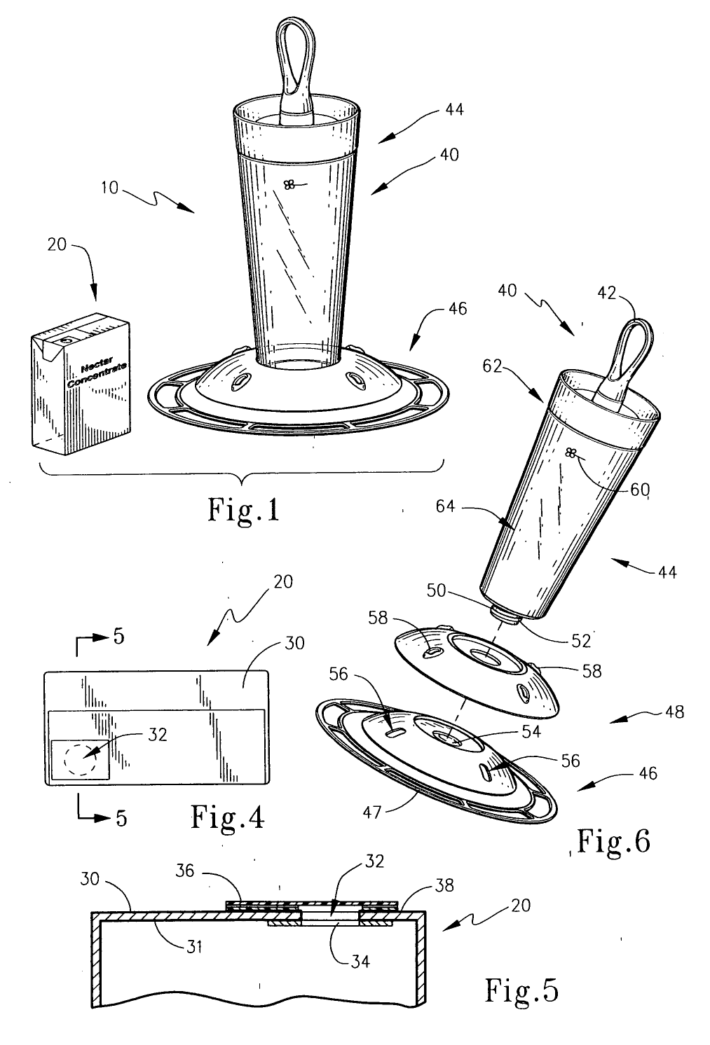

Turning to FIG. 1, it can be seen that feeding system 10, according to the present invention, generally includes a container 20 and hummingbird feeder 40. Container 20 includes a concentrated liquid sugar solution that, when diluted with water, forms a nectar solution that serves as food for attracting hummingbirds. Hummingbird feeder 40 of the present invention includes a reservoir 44 of a selected volume that is able to receiving both a selected volume of the concentrated sugar solution and a selected volume of water whereby the sugar and water can be mixed together to form a suitable nectar solution for attracting hummingbirds.

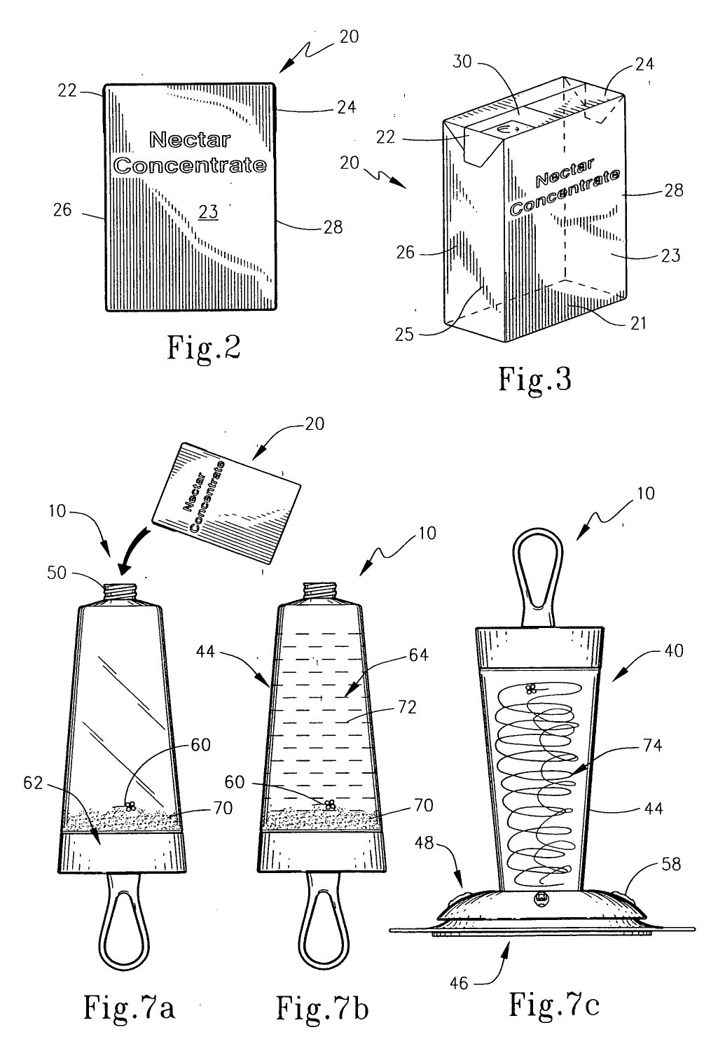

Turning now to FIGS. 2 and 3, container 20, such as that shown here, is common to the liquid packaging industry and is typically used for containing liquids such as milk and fruit juices. Typically, these liquid containers, such as container 20 shown here, are formed of a foldable, liquid impervious material. Container 20 may be of varying sizes and configurations, however it is preferred that it be efficiently sized to hold approximately 8.5 ounces of the concentrated sugar solution. As contemplated here, container 20 is a box and, as such, includes bottom wall 21 and, extending upwardly therefrom, opposing front and back walls 23 and 25 and opposing sidewalls 26 and 28. Container 20 further includes top wall 30, and associated therewith are flaps 22 and 24, which are folded down onto adjacent sidewalls 26 and 28.

As best shown in FIGS. 4 and 5, top wall 30 of container 20 includes opening 32, shown in phantom. Opening 32 is a pour opening, which allows the concentrated sugar solution to be dispensed therethrough. As is also known in the art, opening 32 is associated with seal 34, which is disposed on the interior surface 31 of top wall 30. Preferably, seal 34 preserves the concentrated sugar solution before it is broken, but that can be punctured without great difficulty to pour the concentrated sugar solution therethrough. Container 20 is further provided with closure 36. Closure 36 is preferably a cover strip, or a peel strip such as known in the art, that is releasably securable over opening 32 by adhesive coating 38. Cover strip 36 is preferably sized and adapted to reseal opening 32 to preserve the unused volume of concentrated sugar solution.

As mentioned above, the sugar solution contained in container 20 is concentrated such that when a first volume of the sugar solution is diluted with a second volume of water, the mixture forms a nectar solution suitable of acceptable concentration for attracting and feeding hummingbirds. It is contemplated that 8.5 ounces of the concentrated sugar solution will make approximately 60 ounces of nectar solution such that there is a 1 to 6 ratio of concentrated sugar solution to water.

Turning now to FIG. 6, hummingbird feeder 40 is constructed similar to a conventional hummingbird feeder in that it includes a suspension member 42, reservoir 44 having a selected volume, and base 46 that is securable to the reservoir having a perch 47 extending outwardly therefrom. In addition, hummingbird feeder 40 is shown to further include collar 48 that is interposed between reservoir 44 and base 46. As with conventional hummingbird feeders, reservoir 44 includes reservoir outlet 50 having threads 52 disposed thereon and adapted to mate with threads 54 of base 46. Once mounted thereto, reservoir outlet 50 is in fluid communication with feed outlets 56 whereby liquid in the reservoir is available to a bird at the feed outlet. Collar 48 also includes feed outlets 58 that are adapted align with feed outlet 56 state so that when interposed between reservoir 44 and base 46 in the mounted state, the liquid contained in reservoir 44 is available to the feeding birds.

Unlike conventional hummingbird feeders, however, reservoir 44 includes index marking 60 thereon. Index marking 60 is shown here as a simple line with a decorative flower that may be painted, etched, or otherwise disposed on reservoir 44. Index marking 60 correlates to a selected partial volume and in essence, divides reservoir 44 into two parts by volume to define partial volume 62 and remainder volume 64. As should be appreciated, the remainder volume 64 is the difference between the overall selected volume of reservoir 44 and the partial volume 62. Further, the ratio of the partial volume 62 to the remainder volume 64 is equal to the dilution ratio of the concentrated sugar solution to water, which, as indicated above, is preferably about 1 to 6. Since the purpose of index marking 60 is to partition the selected volume of reservoir 44, markings other than the one shown may be used. A simple line or other decorative indicia are also contemplated.

Now that the components of feeding system 10 have been described in some detail with respect to FIGS. 1-6, it may now be understood how the components may be used together, as exemplified in FIGS. 7a-7c. Turning first to FIG. 7a, reservoir 44 is shown disassembled from the collar and the base of the hummingbird feeder and inverted so that liquids can now be poured into the interior thereof by way of reservoir outlet 50. Here, a selected partial volume 62 of concentrated sugar solution 70 is poured from container 20 into reservoir up to index marking 60. Container 20 can then resealed by means of the cover strip described above, and stored in a refrigerator to preserve the remainder of the concentrated sugar solution therein.

As shown in FIG. 7b, the remainder volume 64 of reservoir 44 is filled with water 72. While FIG. 7b shows a complete separation of concentrated sugar solution 70 and water 72 at index marking 60, the Figure is for illustrative purposes only, and since sugar is soluble in water, one would expect some mixing to occur upon addition of water 72.

Finally, in FIG. 7c, collar 48 and base 46 are returned to a mounted state with reservoir 44. As shown, concentrated sugar solution 70 and water 72 are now thoroughly mixed to form nectar solution 74. The hummingbird feeder 40 may now be turned right side up, as illustrated, and suspended from a support structure so as to make the nectar solution available to a bird via feed outlets 58.

Accordingly, the present invention has been described in great detail with reference to FIGS. 1-7c. It should be appreciated from the foregoing that variations of the constructions described may be made by the ordinarily skilled artisan in this field without departing from the inventive concepts herein. Alternative hummingbird feeder constructions that incorporate a reservoir of a selected volume and index marking, as described above, may be used. For example, the feed ports may be configured as flowers.

Also, as should be appreciated, the present invention further contemplates a method of providing a nectar solution suitable for attracting hummingbirds. The method includes the steps of providing a concentrated sugar solution and a hummingbird feeder such as described above. The method further includes the steps of inverting the reservoir and adding a partial volume of the concentrate into the interior thereof and subsequently adding a sufficient volume of water to dilute the concentrate to achieve the desired dilution ration. The method also includes thereafter securing the reservoir to the feeder base so that the reservoir and the feed outlet are in fluid communication.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

I claim:

1. A feeding system for dispensing liquid food to a bird, comprising:
(A) a container of concentrate that is dilutable with water at a selected dilution ratio of concentrate to water thereby to produce the liquid food for the bird; and
(B) a feeder adapted to be supported by a support structure and including:
(1) a reservoir having a selected volume and a reservoir outlet, said reservoir having an index marking thereon that is correlated to a selected partial volume whereby the ratio of the partial volume to the difference between the selected volume and the partial volume is equal to the dilution ratio for said concentrate, and
(2) a base adapted to mount to said reservoir in a mounted state, said base having at least one feed outlet in fluid communication with the reservoir outlet when in a mounted state whereby liquid in said reservoir is available to a bird at the feed outlet.

2. A feeding system according to claim 1 wherein said feeder is a hummingbird feeder.

3. A method of providing a nectar solution to hummingbirds, comprising:
(A) providing a concentrate that is dilutable with water at a selected dilution ratio of concentrate to water thereby to produce the nectar solution;
(B) inverting a reservoir having a selected volume and an index marking thereon that is correlated to a selected partial volume whereby the ratio of the partial volume to the difference between the selected volume and the partial volume is equal to the dilution ratio for said concentrate;
(C) adding a partial volume of said concentrate to said reservoir;
(D) adding a sufficient volume of water adequate to dilute said concentrate; and
(E) securing said reservoir to a feeder base that is provided with at least one feed outlet such that said reservoir and said feed outlet are in fluid communication.
